(19) United States
(12) Patent Application Publication
(10) Pub. No.: US 2010/0162138 A1
(43) Pub. Date: Jun. 24, 2010

(54) CONVERSATION BUBBLES INCLUDING VISUAL CUES FOR THREADED MESSAGING APPLICATIONS

(75) Inventors: Kristin Marie Pascal, Bothell, WA (US); Andrew Klonsky, Portland, OR (US); Matthew Bailey, Seattle, WA (US)

Correspondence Address: AT&T Legal Department - T&W;Attn: Patent Docketing, Room 2A-207, One AT&T Way, Bedminster, NJ, 07921, US

(73) Assignee: AT&T Mobility II LLC, Atlanta, GA (US)

(21) Appl. No.: 12/343,402

(22) Filed: Dec. 23, 2008

(51) Int. Cl. G06F 3/048; G06F 15/16

(52) U.S. Cl. 715/758

(57) ABSTRACT

The claimed subject matter provides for systems, devices, and methods employing one or more visual cues to conversation bubbles in a threaded messaging environment. As used herein, a threaded messaging environment can include “texting” and other messaging protocols. The visual cues can include indexed conversation bubble tails, color drop-shadow effects, and dynamic adaptive conversation bubble footprints. These visual cues can facilitate rapid visual user comprehension of messages related to particular conversants, the extents of a message, or combinations thereof.

### BACKGROUND

Modern communication devices typically have mechanisms for participating in messaging service protocols such as text messaging by short messaging service (SMS), multimedia messaging service (MMS) instant messaging (IM) applications, IP messaging, email, and the like. Typically, each of these protocols remains a separate and distinct application on a user equipment. Further, many of these protocols employ distinct communications hardware backbones that are distinct and not supportive of cross protocol interactions. As a result, many communications on modern user equipment, commonly referred to as “texting” (which includes SMS, MMS, IM, IP messaging, email, voice snippets, emoticons, visual messaging, and many others), employs multiple protocols, numerous inboxes, outboxes, and commonly third party software applications to facilitate some level of simplifying and unifying the numerous communication avenues.

The negative impact of overlapping and cumbersome “texting” platforms (e.g., any combination of the numerous forms of text/video/voice communications other than a traditional voice phone call) on mobile devices has not gone without notice by device manufacturers, service providers, and third party application developers. Third party developers often are the most nimble and quickest to respond to attempts at fulfilling a long-felt need such as a unified messaging platform to support “texting”. However, many of these third party developers have lacked access to aspects of the hardware and core software of the myriad devices, systems, and protocols for texting. As a result, many third party applications are not robust enough, broad enough, or implemented in an attractive manner and fail to fulfill the long-felt needs of the masses.

Device manufacturers and service providers generally are not as nimble as smaller third party application developers and are more constrained in business decision making and rarely rush to put out product that is friendly to a competitor's product, service, or protocol. As a result, solutions for consumer's long-felt needs may go unfulfilled by device manufacturers and service providers despite these entities having better access to the subsystems and core engineering that would enable them to develop a more ideal system/device in a less competitive environment.

As mobile device technologies become more ubiquitous and begin merging with more traditional computer manufacture and development, products and services are appearing for mobile devices that blur the lines between mobile and traditional notions of non-mobile devices. Interestingly, many business practices have also adapted to the coalescing mobile computing environment. One result of this is more interaction between device manufacturers and service providers in development and standards-setting environments. This is also true across competing platforms where the realization is that consumers will tend to gravitate to a less limiting service or device provider where possible and feasible. Thus, to keep customers, making devices and services competitor friendly has become almost a survival requirement.

The resulting more cooperative development environment is yielding improved services and devices for customers. One area of improvement that will be of great benefit to mobile device users is the move toward unification of messaging systems. There is clearly a desire and long-felt need to simplify and effectively coalesce the plurality of overlapping “texting” communications systems. This is also especially true in cross platform and cross provider conditions. Further, support of legacy devices will be well received by consumers.

One problematic aspect of traditional messaging environments is visualizing communications in a clear and effective manner. Even where there is some form a unified communications inbox and outbox, visualizing each disparate set of communications can be confusing for users, especially under the constraints of limited display area on many modern mobile devices. One effective strategy to improve visualization is threaded messaging communications. Threaded messaging typically strings messages in a linear manner by a predetermined metric, typically time. As such, as each message arrives or is sent between users, the messages are strung together providing more ease in understanding the messages because they are set in the context of the prior messages.

Another form of simplifying communication is to support multiple “conversants” (e.g., multiple “texting” parties) in a single threaded messaging communication. This allows all “texts” to be read in the same display pane, threaded, typically by time. One drawback to this group environment is that distinguishing between different senders and different messages can be increasingly difficult as more conversants are added to a group communication. For example, a two party texting session is easy enough to follow because a user knows what they are texting and thereby can easily determine that the other messages are from the other party. A three party conversation may also be easy enough to follow, though likely needing more attention to ascribe a message to the correct sender as the thread rolls by. As four or five parties are in a conversation, the texts can frequently arrive faster than they are read and management of who texted what can be overwhelming.

Traditional attempts at reducing confusion in group conversation environments have included placing text in particular colors or fonts, wrapping text in colored conversation balloons (CBs), and placing vertical colored bars between individual messages from the same sender in a threaded conversation. Arguably these techniques where applied to mobile devices can cause limited display areas to look somewhat like a cross between a carnival and a spider's web. Clearly there is still much room for improvement in presenting threaded conversations, especially multiparty threaded conversations, to mobile device users that can facilitate efficient and intuitive comprehension of message context in the fast paced mobile messaging environment of the modern mobile device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The claimed subject matter provides for systems, devices, and methods employing one or more visual cues to conversation bubbles (CBs) in a threaded messaging environment. Conversation bubbles are also occasionally called speech bubbles, dialogue balloons, or word balloons, among other names. As used herein, a threaded messaging environment can include “texting” messages (e.g., short messaging service (SMS) messages, multimedia messaging system (MMS) messages, instant messaging (IM) type messages, IP messages, email messages, video snippets, voice snippets, web snippets, twitters, emoticons, etc.) that are threaded, more especially in a mobile device environment. While the list of particular communications protocols is non-exhaustive, it is intended to convey that “texting” incorporates messages of conversational length, including referenced media type objects, exclusive of pure traditional voice conversation as in a telephone call (e.g., a traditional telephone call is not “texting” but a SMS thread that includes voice snippets can be considered “texting”).

Visual cues can include indexed conversation bubble tails, color drop-shadowing, adaptive conversation bubble footprints, and combinations thereof. With regard to conversation bubble tails, a conversation bubble will frequently have a tail or a leader in printed material, for example tails or leaders are commonly used in comics to denote the speaker of each bubble in any particular comic strip pane. As conventionally used in threaded messaging, conversation bubbles traditionally have a left or right side tail, with the convention being that a device owner has a right oriented conversation bubble and tail and other conversants' communications have a left oriented conversation bubble and tail. Indexing the position of the tail to correspond to particular conversants can facilitate visual association of conversation bubbles with the corresponding conversant.

Drop-shadows are also commonly used in printed material to provide emphasis to objects by causing them to appear visually out of plane with the remainder of the immediately surrounding image. Drop-shadows are also used in many graphical user interfaces to provide a sense of depth. Drop-shadows can be grey scale or color. Traditional threaded messaging systems commonly employ colored text or colored conversation bubbles and, as a result, could create a visually overwhelming environment filled with large amount of color or difficult to read text (due to contrast issues between the text and the background color). In contrast, a subtle color drop-shadow can provide a powerful visual cue without being garish. This visual cue can be so subtle as to almost be an unconscious visual cue, e.g., it is less intrusive in the conversation but is still effective at providing an effective visualization of conversants in a threaded messaging environment.

Communication bubbles traditionally surround some texting objects (e.g., actual text, some emoticons, etc.) but not others (e.g., maps, pictures, video, some emoticons, etc.). This somewhat erratic use of communication bubbles in a threaded environment can be a source of confusion to conversants. More consistent use of a surrounding conversation bubble can be an effective visual cue for discerning between conversants by more clearly demarking the extents of any message in the threaded conversation. A dynamically adaptable footprint for a conversation bubble can be beneficial by consistently encompassing the common components of modern “text messages” (e.g., pictures, video, actual text, maps, emoticons, etc. all can be placed inside a conversation bubble.)

In accord with an aspect of the claimed subject matter, a threaded messaging environment can employ conversation bubble tails, drop-shadowing of conversation bubbles, inclusive conversation bubble footprints, or combinations thereof to provide effective visual cues facilitating association of messages with the related conversant. In accordance with another aspect, conversation bubble tails can be indexed. An index of the conversation bubble tail can correlate with specific conversants. In accordance with another aspect, conversation bubble drop-shadowing can include color drop-shadowing. A particular color of a drop-shadow can correlate with a specific conversant. Similarly, in another aspect, a combination of indexing conversation bubble tails and applying color drop-shadows can correlate specific conversants with a particular combination of index and color. In accordance with a further aspect of the disclosed subject matter, conversation bubble footprints can be adapted to visually surround the contents of messages in a threaded messaging environment to facilitate easy identification of the extents of a particular message in the thread. In a further aspect, the conversation bubble footprint can be dynamically adapted to visually surround message contents where the footprint of the message contents can change. As such, a conversation bubble can surround an image place holder icon and then the conversation bubble can grow to encompass the image that replaces the place holder icon. Similarly, the conversation bubble can shrink to surround the place holder icon where the image is degraded from an image to a place holder icon.

Certain illustrative aspects of the disclosed innovation are described herein in connection with the following description and the annexed drawings. These aspects are indicative, however, of but a few of the various ways in which the principles disclosed herein can be employed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an exemplary system that facilitates applying visual cues in a threaded messaging environment in accord with aspects of the claimed subject matter.

FIG. 2 depicts an exemplary system that facilitates applying visual cues in a threaded messaging environment in accord with aspects of the claimed subject matter.

FIG. 3 illustrates an exemplary method facilitating employing visual cues in a threaded messaging environment in accord with aspects of the claimed subject matter.

FIG. 4 an exemplary method facilitating employing visual cues in a threaded messaging environment in accord with aspects of the claimed subject matter.

FIG. 5 illustrates an exemplary method facilitating employing visual cues in a threaded messaging environment in accord with aspects of the claimed subject matter.

FIG. 6 depicts an exemplary method facilitating employing visual cues in a threaded messaging environment in accord with aspects of the claimed subject matter.

FIG. 7 depicts, in an exemplary illustrative representation, exemplary aspects of visual cues in accord with aspects of the claimed subject matter.

FIG. 8 depicts, in an exemplary illustrative representation, exemplary aspects of visual cues in accord with aspects of the claimed subject matter.

FIG. 9 illustrates a sample operating environment that can determine and store information related to a missed call in accord with aspects of the claimed subject matter.

FIG. 10 depicts a sample network-environment for effectuating mobile communication in accord with aspects of the subject innovation.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components, and can be as simple as a command line or a more complex Integrated Development Environment (IDE).

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

It will be appreciated by one of skill in the art that a communication network for systems described herein can include any suitable mobile and/or landline based circuit-switched communication network including a GSM network, a time division multiple access (TDMA) network, a CDMA network, such as IS-95 and subsequent iterations of CDMA technology, an integrated digital enhanced network (iDEN) network and a public switched transport network (PSTN). Further examples of a communication network can include any suitable data packet-switched or combination data packet/circuit-switched communication network, e.g., a wired or wireless internet protocol (IP) network such as a voice over internet protocol (VoIP) network, an IP data network, a universal mobile telecommunication system (UMTS) network, a general packet radio service (GPRS) network, and other communication networks that provide streaming data communication over IP and/or simultaneous voice and data communication over combination data packet/circuit-switched technologies.

Similarly, one of skill in the art will appreciate that a communication device for systems disclosed herein can include a mobile device, mobile phone, a PSTN phone, a cellular communication device, a cellular phone, a satellite communication device, a satellite phone, a VoIP phone, a WiFi phone, a dual-mode cellular/WiFi phone, a combination cellular/VoIP/WiFi/WiMAX phone or any suitable combination thereof. Specific examples of a mobile device can include cellular devices such as GSM, TDMA, CDMA, IS-95 and iDEN phones and cellular/WiFi devices such as dual-mode GSM, TDMA, IS-95 or iDEN/VoIP phones, UMTS phones UMTS VoIP phones, or like devices or combinations thereof. In support of mobile devices a gateway routing component of such a system can include any suitable component that can perform centralized routing within a mobile, satellite, or similar network (but optionally does not include components that route strictly within a PSTN network), routing between communication networks, between networks of varying architecture (e.g., between PSTN, GSM, UMTS, Enterprise VoIP, the Internet, or combinations thereof), or the like. Specific examples of a gateway routing component can include a GMSC, a gateway GPRS support node (GGSN), a session border control (SBC) device, or like devices. Additionally, a data storage component of such a system can include any suitable device, process, combination device and process, etc., that can store digital and/or switched information (e.g., server, database, data store, or the like).

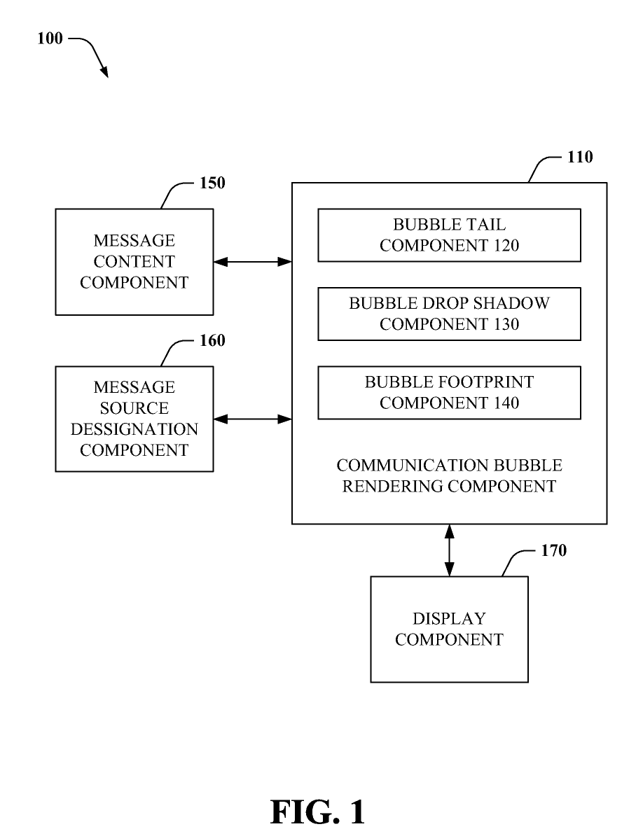

FIG. 1 depicts an exemplary system 100 that facilitates applying visual cues in a threaded messaging environment in accord with aspects of the claimed subject matter. System 100 can include communication bubble (CB) rendering component 110. Communication bubble rendering component 110 can facilitate rendering of CBs in threaded messaging environments. Communication bubble rendering component 110 can include bubble tail component 120. Bubble tail component 120 can aid in determining characteristics of bubble tails. Communication bubble rendering component 110 can also include bubble drop-shadow component 130, which can facilitate implementing drop-shadows with communication bubbles. Further, communication bubble rendering component 110 can include bubble footprint component 140. Bubble footprint component 140 can facilitate determining the footprint of CBs, more particularly CBs that encompass the extents of threaded conversation elements for a particular message.

System 100 can further include message content component 150. Message content component 150 can facilitate communicating information relating to the content of a message to communication bubble rendering component 110. For example, where a message includes an image that is 64 pixels by 64 pixels, this information can be communicated to bubble footprint component 140 in communication bubble rendering component 110, such that the footprint of the communication bubble can be determined so as to include the image within the extents of the CB. The resulting rendered communication bubble can assist the user in determining the bounds of individual messages within a threaded messaging conversation.

System 100 can also include message source designation component 160. Message source designation component 160 can provide information related to the source of a message to communication bubble rendering component 110. This message source information can include, for example, identification of the conversant sending the message, the time and date the message was sent, the time and date the message was received, the type of device the message was sent from, or combinations thereof among numerous other information related to the source designation of a message. This information can be used in determinations affecting the rendering of a CB. For example, information related to the sender of a message can be employed in determining aspects of drop-shadows and bubble tails used with rendered CBs.

System 100 can further be communicatively coupled to a display component 170. Display component 170 can provide information to communication bubble rendering component 110 to aid in determinations related to rendering CBs. For example, where a mobile device has a 240×320 display area, it can be desirable to render CBs differently than where a mobile device has a 240×260 display area. Information relating to the display area can be provided by display component 170.

In accordance with an aspect of the disclosed subject matter, system 100 can incorporate visual cues into messages associated with a threaded messaging environment. These visual cues can aid conversants in determining “who said what” by helping to more clearly identify the bounds of a conversants message and to associate particular visual characteristics of the communication bubble with a particular conversant.

In an aspect, a conversation bubble can have a tail (e.g., leader, pointer, etc.) that serves as a visual cue to aid in identifying the source of the content of the CB. Threaded messaging CBs can incorporate tails to visually steer a user through a string of messages, for example tails on the right can identify the device owner and tails on the left can identify all other conversants. A user can quickly ascertain when a communication bubble is from the user themselves or from anther conversant merely by observing the left-right orientation of the communication bubble tails. The left-right tail schema becomes less effective in a group threaded conversation where there can be multiple other conversants that can all be associated with a “left tail” conversation bubble.

In a further aspect in accordance with the disclosed subject matter, indexed conversation bubble tails can be employed as visual cues. An indexed tail can be a tail associated with a first conversant that is indented to a different index than another tail associated with a second conversant. These indexed indentations (including right justified indexing and left justified indexing) can provide rapid visual identification of an associated conversant. For example, in a four conversant texting conversation conversant one can be right justified, conversant two can be left justified, conversant three can be left justified at indent index L1, and conversant four can be left justified at indent index L2. As messages populate the conversation pane and are threaded, conversant one can rapidly identify messages associated with conversant four because they all include a communication bubble tail left justified at indent index L2.

In a further aspect of the disclosed subject matter, indexed tails can be selected and associated with conversants based in part on numerous other criteria. One of skill in the art will appreciate that these additional criteria encompass a nearly limitless number of pieces of information that can be leveraged to provide additional information to conversants and that all such criteria are considered within the scope of the disclosed subject matter. For example, indexing can be left-right oriented with indent indexes such that conversants associated with a first group are right justified and indent indexed and conversants associate with a second group are left justified and indent indexed. This can be beneficial in many situations, including for example, a conversation between two employees each from two different departments, wherein the first employee of the first department is right justified, the second employee of the first department is right justified at indent index R1, the first employee of the second department is left justified, and the second employee of the second department is left justified at indent index L. This provides all conversants with the knowledge that right justified communication bubble tails indicate department one and each conversant therein is associated with a particular indent index and that this is mirrored for the second department (e.g., department two is left justified with different left indents for the conversants from the second department).

In a still further aspect, communication bubble tails can be indexed with different orientations to provide visual cues. One of skill in the art will appreciate that the number of placement options for communication bubble tails is large and that all such indexed positions reasonably fall within the scope if the present disclosure. These additional indexing positions can include vertical indexed orientations, horizontal indexed orientations, indexed tail lengths, indexed tail angles, indexed styles (e.g., shapes, visualizations, etc.) for communication bubble tails, etc. For example, a first conversant can employ a lightning bolt as a communication bubble tail and be considered differently indexed that a standard communication bubble tail at the same position.

In accordance with another aspect of the disclosed subject matter, drop-shadows can serve as a visual cue to aid in identifying the particular conversant as the source of the content in a message. Drop-shadows can create an illusion of depth. As such, drop-shadows of different “depths” can be used to identify different conversants. Drop-shadows can similarly employ different levels of opacity. These levels of opacity can be employed to identify particular conversants.

In a particular aspect, color drop-shadows can be employed to aid in identification of particular conversants. Moreover, color drop-shadows can be very subtle cues that can facilitate identification of conversants without excessive use of colors that can be distracting to users. One of skill in the art will appreciate that additional criteria can be associated with drop-shadowing, that these criteria encompass a nearly limitless number of pieces of information that can be leveraged to provide additional information to conversants, and that all such criteria are considered within the scope of the disclosed subject matter. In an example, warmer/red colors can be associated with conversants of high importance while cooler/blue colors can be associated with less important conversants. As such, a company vice-president can be associated with a red drop-shadow while a vendor can be associated with a blue/green drop-shadow. This color identification therefore not only allows rapid visual acquisition of all red drop-shadowed conversations but also relates that these messages are associated with a high importance conversant. Similar examples can easily be identified for use of levels of opacity and/or “depths” of drop-shadows or color drop-shadows and all such examples are considered within the scope of the present disclosure as will be appreciated by one of skill in the art.

In accordance with another aspect of the disclosed subject matter, conversation bubble footprints can be generated to encompass the entirety of an individual message in a threaded conversation. This can facilitate rapid visual acquisition of the bounds of a particular message and can aid in differentiating a first message form an adjacent message. For example, where a first message includes an image related to the content of text string in an adjoining message, encompassing the image in the footprint of the first communication bubble more clearly defines the image as part of the first message rather than part of the adjoining message. One of skill in the art will appreciate that many forms of content can be included in a “texting” environment and that adapting a communication bubble footprint to encompass any of these forms of content is within the scope of the present disclosure.

In an additional aspect, content included in “texts” (e.g., messages in a threaded messaging environment) can change form factor for a variety of reasons, such as, change in focus, change in display pane position, evolution of the content over time or in response to a user action such as animated GIFs or mouse-over content objects, etc. Bubble footprints can be dynamic so as to encompass the messaging content adaptively when the form factor of the content changes. Thus for example, a conversation bubble footprint can grow dynamically to encompass an image that transitions between a thumbnail and a larger image as the user scrolls over the message with the image (e.g., the image enters the focused state). Similarly, as the user moves focus away from the message with the image, the image can be degraded back to a thumbnail and the communication bubble can be dynamically shrunk to encompass the smaller image in a reduced footprint that consumes less display area.

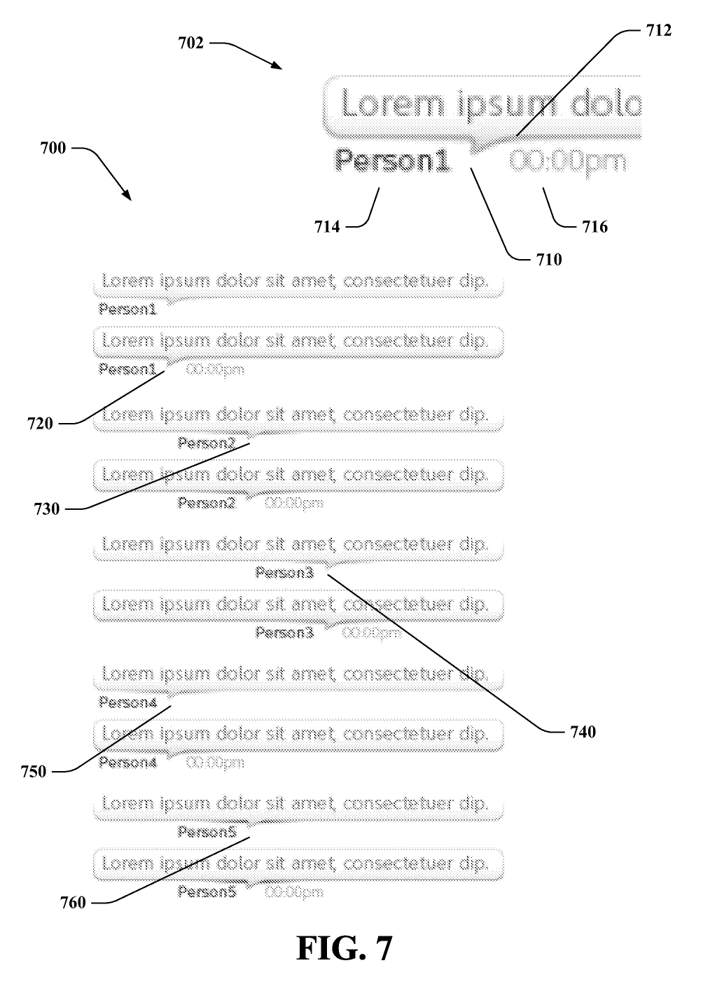

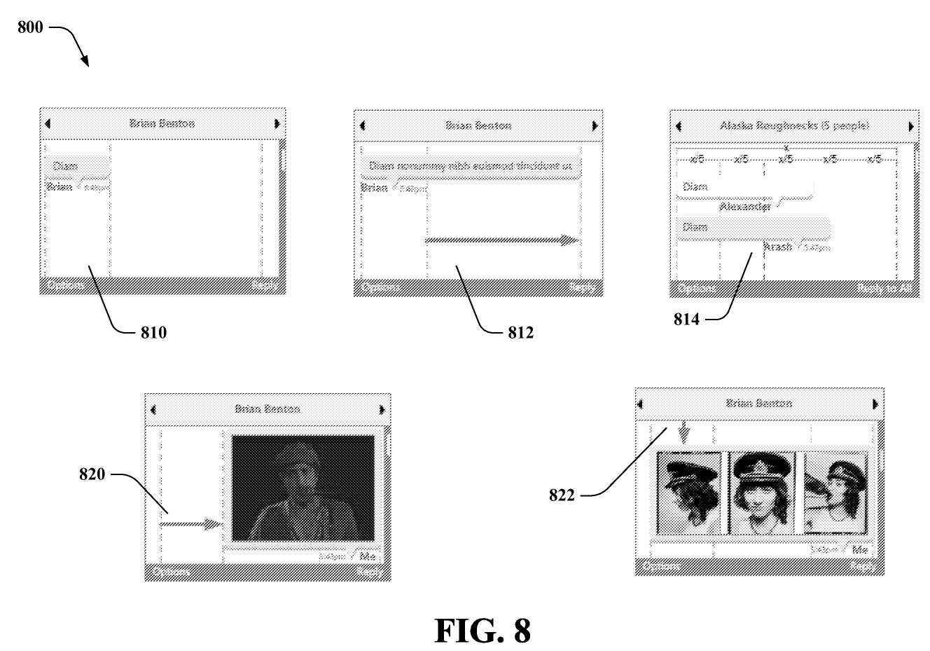

In a further aspect in accordance with the disclosed subject matter, each of these visual cue features can be used in combination to provide for an efficient visualization of threaded messaging. As is apparent, visual cues are powerful tools for rapid comprehension of a string of threaded messages, this being even truer in a group threaded conversation with a plurality of conversants. As will be appreciated by one of skill in the art that is familiar with crowded online chat rooms or complex email threads having large numbers of participating addressees, tools to aid in understanding “who said what” are important and even subtle improvements in this art are well received by users. Exemplary illustrations are given at FIG. 7 and FIG. 8 and will be discussed herein. In an example, a conversation bubble can be dynamically adapted to encompass an animated GIF included in-line with text and an icon for an audio file send as message from a conversant participating in a group threaded messaging conversation. The conversant can be a manager and can be associated with a yellow drop-shadow and a left justified indent index of L2. Identification of messages from the manager can easily be visually identified as they appear in the thread (or when scrolling through a thread history) because the conversation bubble has an indexed tail at L2 and a subtle yellow drop-shadow. The contents of each message from the manager are also easily identifiable because they are within the confines of the conversation bubble and that bubble dynamically adapts to the content of the bubble as the state of the content changes. One of skill in the art will appreciate that numerous other examples of various permutations of the disclosed subject matter are possible and will further appreciate that all such embodiments are within the scope of the disclosure despite the impracticability of disclosing each of them explicitly herein.

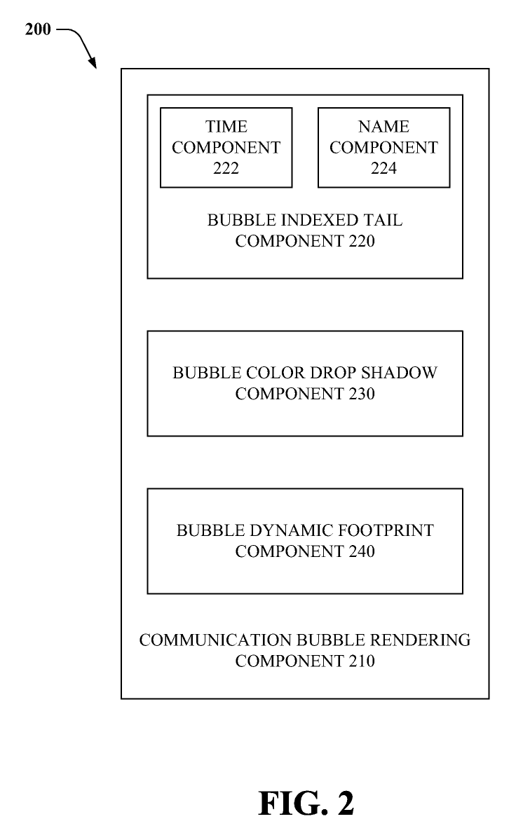

FIG. 2 depicts an exemplary system 200 that facilitates applying visual cues in a threaded messaging environment in accord with aspects of the claimed subject matter. System 200 can include communication bubble rendering component 210. Communication bubble rendering component 210 can be the same as, or similar to, communication bubble rendering component 110. Communication bubble rendering component 210 can include bubble indexed tail component 220, bubble color drop-shadow component 230 and/or bubble dynamic footprint component 240. Bubble indexed tail component 220 can be the same as, or similar to, bubble tail component 120, bubble color drop-shadow component 230 can be the same as, or similar to, bubble drop-shadow component 130, and bubble dynamic footprint component 240 can be the same as, or similar to, bubble footprint component 140.

In an aspect, bubble color drop-shadow component 230 can facilitate incorporation of color drop shadows with conversation bubbles as visual cues in a threaded messaging environment as disclosed herein. Similarly as has been disclosed herein, bubble dynamic footprint component 240 can dynamically adapt communication bubble footprints to accommodate content with the communication bubble to aid in identifying the bounds of a message within a conversation thread.

In a further aspect, bubble indexed tail component 220 can provide for indexed placement of conversation bubble tails to aid in rapid visual acuity in identifying a conversant related to a particular communication bubble tail index as disclosed herein. Bubble indexed tail component 220 can further include time component 222 and name component 224. Time component 222 can insert a time/date or other identifier into a rendering of a communication bubble. This can, for example, aid in communicating information related to an arrival time of a message. This can be particularly useful where a user is unable to view messages for a period of time and then reviews the thread. In a particular example, the identifier inserted by time component 222 can be inserted proximal to the indexed tail. Moreover, the footprint of the inserted identifier can be considered in determinations on the spatial placement of the indexed tail (e.g., the inserted identifier can be considered as part of the tail when indexing the tail).

Name component 224 can facilitate inserting an identifier related to the identity of a conversant into a rendering of a communication bubble. This can, for example, aid in communicating information related to the identity of the sender of a message. For example, a first name, last name, phone number, nickname, or other identifier can be inserted in to the communication bubble rendering. The identifier of the name component 224 can be inserted proximal to an indexed tail. The footprint of the inserted identifier can be considered in determinations on the spatial placement of the indexed tail (e.g., the inserted identifier can be considered as part of the tail when indexing the tail).

In a further embodiment, both a time component 222 and a name component 224 identifier can be inserted into a communication bubble rendering, and more particularly, inserted proximal to a communication bubble tail. This augmentation of the communication bubble tail can further improve rapid discrimination between different conversants in a threaded messaging environment. One of skill in the art will appreciate that the aforementioned identifiers can be employed in conjunction with the various permutations of the disclosed embodiments herein and that any such combination is also considered within the scope of the disclosed subject matter.

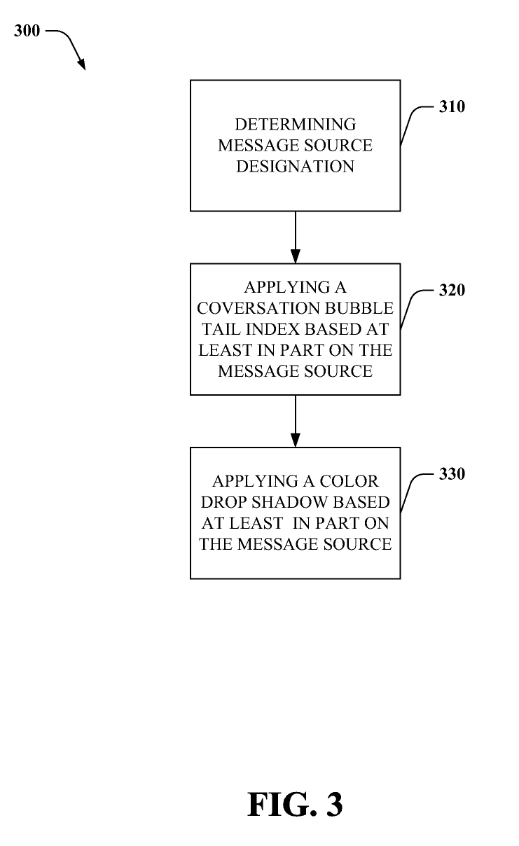

FIGS. 3, 4, 5, and 6 depict exemplary methodologies in accord with the claimed subject matter. While, for purposes of simplicity of explanation, the methodologies are shown and described as a series of acts, it is to be understood and appreciated that the claimed subject matter is not limited by the order of acts, as some acts can occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with the claimed subject matter. Additionally, it should be further appreciated that the methodologies disclosed hereinafter and throughout this specification are capable of being stored on an article of manufacture or other computer readable storage medium to facilitate transporting and transferring such methodologies to computers.

FIG. 3 illustrates an exemplary methodology 300 facilitating employing visual cues in a threaded messaging environment in accord with aspects of the claimed subject matter. At 310, methodology 300 determines a message source designation. The method source designation can include information related to the identity of the sender of the message, times, dates, device information, or other information related to the source of the message. This information can be leveraged as disclosed herein to aid conversants in associating particular visual cues with other conversants. An exemplary message source designation can, for example, be determined to include the first name, last name, nick name, origin phone number, origin device manufacturer, origin device model, origin device software version identifier, origin device capability hash, message time stamp, message date stamp, and message content object.

At 320, a conversation bubble tail index can be applied in a conversation bubble tail rendering based at least in part on message source designation information determined at 310. For example, the tail can be rendered with a proximal nickname and time stamp and be indent indexed as an identified conversant based on the first name, last name, and origin phone number (e.g., the indent index will be the same as the remaining tails for the same conversant identified in this example by first and last name in combination with the originating phone number.) One of skill in the art will appreciate, in light of the present disclosure, that a nearly limitless number of permutations for indexing the conversation bubble tail, as disclosed at 320, can be accomplished by employing information related to the message source, as described at 310, and that all such permutations are within the scope of the present disclosure.

At 330 a drop-shadow can be applied to a conversation bubble. This drop-shadow can be a color drop-shadow. Application of the color drop-shadow can be a visual aid for associating message with particular conversants and as such, application of the color drop-shadow at 330 can be based at least in part on message source designation information determined at 310. For example, a message related to an identified conversant (e.g., as in the above example, a conversant identified by first and last name and originating phone number) can have a color drop-shadow applied in the rendered conversation bubble (e.g., the color drop shadow remains consistent for messaging conversation bubbles from the identified conversant.) At this point methodology 300 can end.

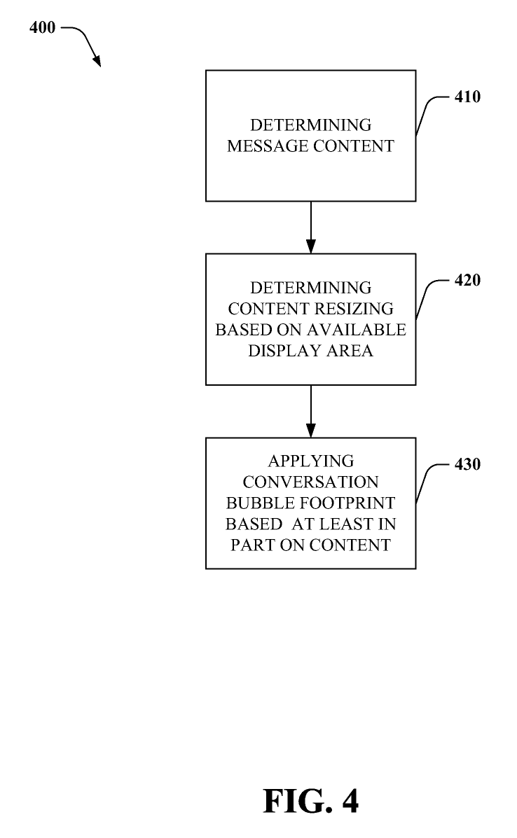

FIG. 4 illustrates an exemplary methodology 400 facilitating employing visual cues in a threaded messaging environment in accord with aspects of the claimed subject matter. At 410, methodology 400 can determine a message source designation. The method source designation can include information related to the identity of the sender of the message, times, dates, device information, or other information related to the source of the message. This information, similar to that described for methodology 300, can be leveraged as disclosed herein to aid conversants in associating particular visual cues with other conversants. Also as in methodology 300, an exemplary message source designation can, for example, be determined to include the first name, last name, nick name, origin phone number, origin device manufacturer, origin device model, origin device software version identifier, origin device capability hash, message time stamp, message date stamp, and message content object.

At 420, any resizing of content, for example, based on available display area (or otherwise related to available display area) can be determined. This can be a result of content intended for a display pane being resized to fit with a designated portion of the display pane by systems, devices, or methods outside the scope of the instant subject matter. Message content can be identified from 410 and resizing information can be provided by a rendering system, device or method (not illustrated). Where content is to be resized, this information can be leveraged to facilitate an appropriate footprint for a conversation bubble encompassing the message content.

At 430, a conversation bubble footprint based at least in part on the content (or resizing thereof) can be applied to the rendering of the message in the conversation thread. As stated herein, a conversation bubble can facilitate identifying the bounds of a message where the message content is contained within the bounds of the conversation bubble depiction. Methodology 400 facilitates sizing a conversation bubble to encompass a message contents based on the displayed footprint of the message contents. At this point methodology 400 can end.

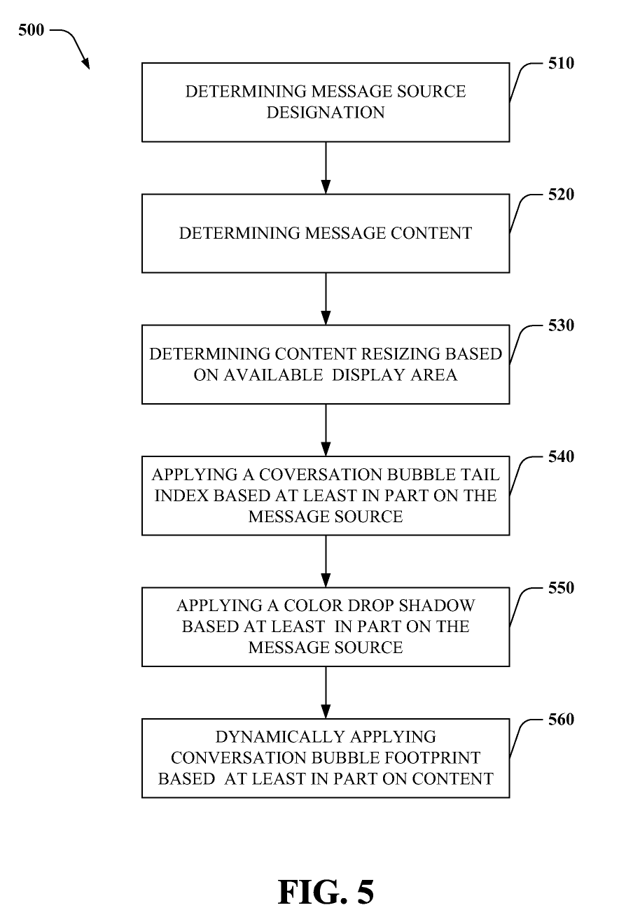

FIG. 5 illustrates an exemplary methodology 500 facilitating employing visual cues in a threaded messaging environment in accord with aspects of the claimed subject matter. At 510, message source designations information is determined. At 520, message content is determined. At 530 resizing of message content to adapt to a display device area is determined, this can be the same or similar to 420 of methodology 400.

At 540, a conversation bubble tail index can be applied in the same or similar manner to 320 of methodology 300. At 550, a color drop-shadow based at least in part on the message source designation can be applied the same or similar to 330 of methodology 300.

At 560 a conversation bubble footprint can be rendered based at least in part on the content of the message. This application of a communication bubble footprint can be dynamic. Further, the rendering includes rendering of the applied indexed communication bubble tail and color drop-shadow from 540 and 550 respectively. At this point methodology 500 can end. Dynamic application of communication bubble footprint connotes that the communication bubble footprint adapts with changes in the content of the message. For example, as disclosed herein, where an image size changes, the footprint can dynamically adapt to encompass the new size of the image within the conversation message. This allows methodology 500 to consistently encompass individual messages in a threaded conversation despite changes in the content.

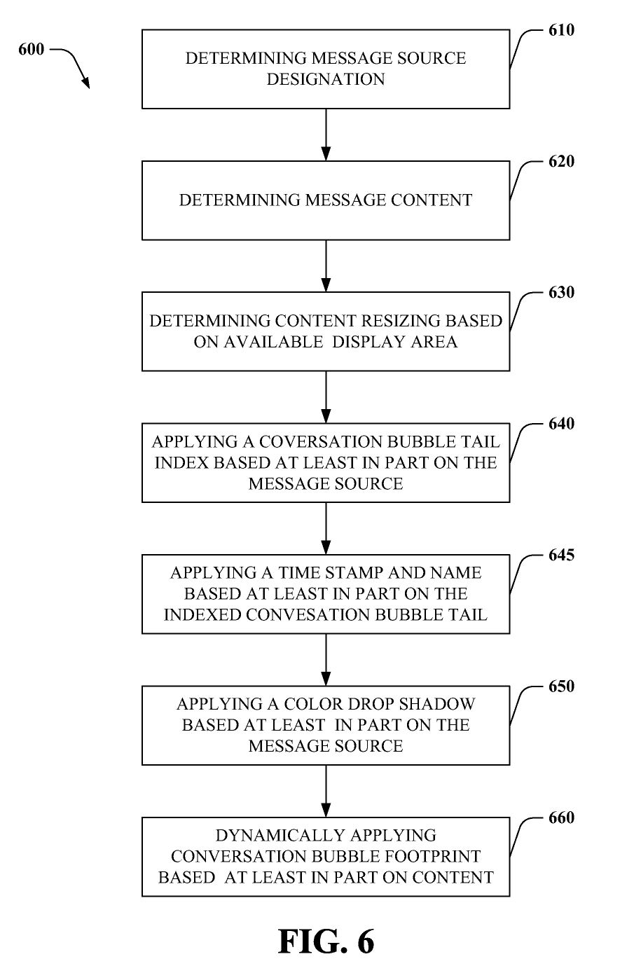

FIG. 6 illustrates an example methodology 600 facilitating employing visual cues in a threaded messaging environment in accord with aspects of the claimed subject matter. At 610, message source designations information is determined. At 620, message content is determined. At 630 resizing of message content to adapt to a display device area is determined, this can be the same or similar to 520 of methodology 500.

At 640, a conversation bubble tail index can be applied in the same or similar manner to 540 of methodology 500. At 645, a time stamp and name can be applied for the render of the message. This can facilitate conveying additional identification information to users by for example including a nickname and date stamp proximal to the communication bubble tail in a rendered conversation bubble as disclosed herein. At 650, a color drop-shadow based at least in part on the message source designation can be applied the same or similar to 550 of methodology 500.

At 660 a conversation bubble footprint can be rendered based at least in part on the content of the message. This application of a communication bubble footprint can be dynamic. Further, the rendering includes rendering of the applied indexed communication bubble tail and color drop-shadow from 640 and 650 respectively. At this point methodology 600 can end. Dynamic application of communication bubble footprint connotes that the communication bubble footprint adjusts with changes in the content of the message. For example, as disclosed herein, where an image size changes, the footprint can dynamically adapt to encompass the new size of the image within the conversation message. This allows methodology 600 to consistently encompass individual messages in a threaded conversation despite changes in the content.

Methodologies 300, 400, 500, and 600 each only differ slightly, however these subtle differences can be related to significant differences in end user acceptance. As has been experienced historically, overly complicated and cluttered interfaces frequently fail to satisfy long-felt needs in the computer arts. Where threaded messaging (e.g., “texting”, etc.) is becoming increasingly ubiquitous in mobile devices, and mobile devices generally have more limited display areas than non-mobile devices, the simple elegance of an interface can be extremely important. It is generally not obvious to include the “right mix” of known and novel elements into a new user interface that will meet the long-felt needs of messaging communities. This is evidenced by the slews of failed and failing user interfaces and the rise of but a few interfaces that are very narrowly defined in scope and protocol. Merely throwing various features into a user interface is unlikely to result in an effective solution.

FIG. 7 is an exemplary illustrative representation depicting exemplary aspects of visual cues in accord with aspects of the claimed subject matter. FIG. 7 includes illustrations 700 and 702, each being a simple illustration of but one possible embodiment of the disclosed subject matter. They are presented to facilitate understanding of the present disclosure. These examples, and the related following examples, are not presented to limit the claims to the examples presented and should not be construed as limiting the scope of the present disclosure in any way.

Illustration 702 depicts a communication bubble tail 710 that is visible depending from a conversation bubble containing a content object including the text, “Lorem ipsum dolo . . . ” Illustration 702 further includes a color drop-shadow 712. The exemplary color drop-shadow 712 is a very subtle effect and does not extend along the entire conversation bubble, though it is not so limited. This particular example of the color drop-shadow 712 is presented to emphasize that the color drop-shadow as disclosed herein can be a very subtle effect that can be purposefully understated and unobtrusive while still providing a strong visual cue for grouping of correlated messages form a conversant in a threaded messaging environment. This subtle effect can, of course, also be implemented in a more intense and intrusive manner. Of note, the color drop-shadow differs from coloring message text itself (e.g., a colored font), coloring conversation bubbles themselves (e.g., colored border defining a conversation bubble area), or color filling conversation bubbles themselves with a solid or gradient color. The subtly of the color drop-shadow effect reduces the busyness of a displayed conversation thread as compared to other methods of coloration. Further, the color drop-shadow does not interfere with the readability of text in the conversation bubble because the coloration is external to message content portion of the conversation bubble.

Illustration 702 further includes a name component identifier 714 and a time component identifier 716 located proximal to the bubble tail 710. As can be observed, where the name and time identifiers (714, 716) are proximal to the tail 710, they can be rendered as part of the tail indexing (here the indexing is left justified with the conversation bubble.) Looking at illustration 700, the index of the tail (e.g., with or without the name and/or time identifiers) can be indent indexed. This is clearly observable in the horizontal indexed positions of the tails 720 (left justified), 730 (left justified at index L1), and 740 (left justified at index L2). Comparing tail index 720 to tail index 730 to tail index 740 in a vertical manner facilitates almost instantaneous distinction between the associated conversants for each message set.

Illustration 700 further depicts communication bubble tail 750 (left justified) and 760 (left justified at index L1). In an aspect, if only indexed tails are employed, there can be confusion with regard to the relationship between tail 720 and tail 750 being associated with different conversants (and similarly between tail 730 and tail 760). In an aspect, employing the name identifier in the rendering of the indexed tail can facilitate effective differentiation between two tails with a similar left justification that are, however, associated with different conversants (because the name identifiers can be required to be different where a same index is employed). This can be effective but less desirable where reading a name can be cumbersome despite the high level of fidelity provided.

Also visible in illustration 700 are color drop-shadows (see 720-760). These color drop-shadows can provide a highly efficient visualization of message to conversant correlation. As depicted, the use of color drop-shadows is combined with indexed communication bubble tails, but the disclosure is expressly not so limited in alternate embodiments. Where the color drop-shadows are employed with indexed communication bubble tails, it is clear that tail 720 is related to a different conversant than tail 750 (and similarly tail 730 is not the same conversant as tail 760) even without having to read the name identifier.

Also illustrated in depiction 700, is an encompassing conversation bubble defining the bounds of each textual message. It is clear that each message is separate from the messages proximal to it. While other examples of the adaptive conversation bubble footprint are presented herein with regard to non-text objects, it is noteworthy that it is effective even for mere textual message content.

Overall, illustrations 700 and 702 demonstrate that particular embodiments of the disclosed subject matter can provide effective visual cues to rapidly identify and correlate messages with conversants in a threaded messaging environment. The use of color drop-shadows in combination with indexed communication bubble tails provides an intuitive metric to visually group conversants. This intuitive grouping is reinforced by the inclusion of name and/or time identifiers. Further, the extent of each message in the messaging thread is clearly and rapidly discernable. This is but one possible embodiment of the disclosed subject matter and is not presented to limit the disclosure in any manner, rather being presented to positively illustrate aspects of the disclosure for more clear comprehension.

FIG. 8 is an exemplary illustrative representation depicting exemplary aspects of visual cues in accord with aspects of the claimed subject matter. FIG. 8 includes illustration 800, a simple set of illustrative panes of some possible embodiments of the disclosed subject matter. Illustration 800 is presented to facilitate understanding of the present disclosure. These examples and the related following examples are not presented to limit the claims to the examples presented and should not be construed as limiting the scope of the present disclosure in any way.

In illustration 800, the footprint of the conversation bubble is illustrated as being at least in part dependent on the message contents. Comparing the size (e.g., footprint) of the conversation bubble at 810 to that of 812 it is clear that the increased textual volume at 812 results in a larger footprint for the encompassing conversation bubble. Similarly, the CBs for 820 and 822 illustrate that the bubble footprints are adapted to encompass the content of the message. Further, where the image, for example in 820, is reduced to fit a limited display area such as on a mobile device, the conversation bubble can be adapted to surround the reduced image fitting within the limited display area.

Also of note is that a “minimum” bubble footprint can be related to the indexed communication bubble tail as illustrated at 814. In illustrative pane 814, the upper conversation bubble is larger than needed to encompass the text because the rendering is adapted to also account for the indexing of the communication bubble tail and proximal name identifier (indent indexed at x/5). Similarly, the lower communication bubble in pane 814 is also larger than needed to encompass the text and is in fact even larger than the upper CB. This larger footprint is related to adapting the conversation bubble to account for the even deeper indent index of the communication bubble tail and name identifier (indent indexed at 2x/5). Also included in the lower communication bubble of pane 814 is a time identifier proximal to the indexed communication bubble tail. These particular examples and any the related examples are not presented to limit the claims with respect to the examples herein presented, and as such, should not be construed as limiting the scope of the present disclosure in any way.

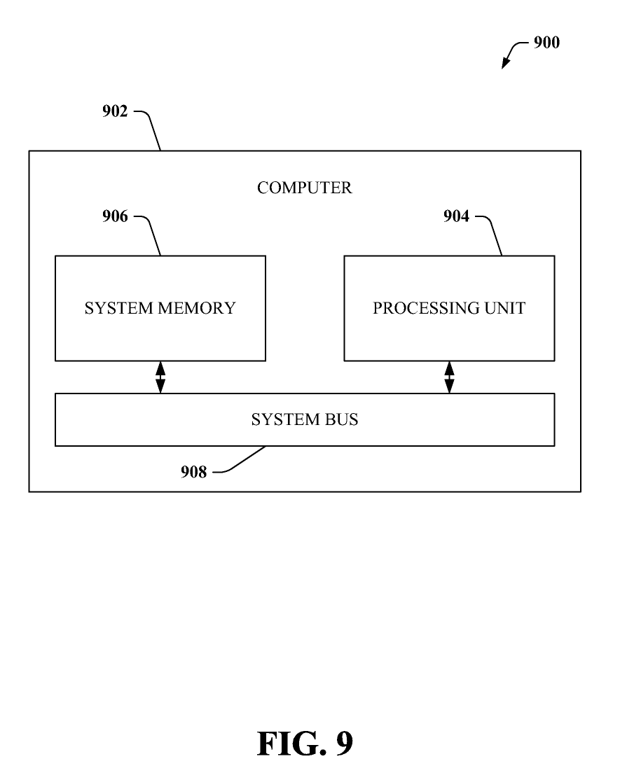

In order to provide additional context for various aspects of the claimed subject matter, FIG. 9 and the following discussion are intended to provide a brief, general description of a suitable computing environment 900 in which the various aspects described herein can be implemented. While the description above is in the general context of computer-executable instructions that can run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of communication media derived from computer-readable media and capable of subsequently propagating through electrically conductive media, (e.g., such as a system bus, microprocessor, data port, and the like) and/or non-electrically conductive media (e.g., in the form of radio frequency, microwave frequency, optical frequency and similar electromagnetic frequency modulated data signals).

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors, such a single core processor, a multi-core processor, or any other suitable arrangement of processors. The system bus 908 can be any of several types of bus structure that can further interconnect to a memory bus (with or without a memory controller), a peripheral bus, and a local bus using any of a variety of commercially available bus architectures. The system memory 906 can include read-only memory (ROM), random access memory (RAM), high-speed RAM (such as static RAM), EPROM, EEPROM, and/or the like. Additionally or alternatively, the computer 902 can include a hard disk drive, upon which program instructions, data, and the like can be retained. Moreover, removable data storage can be associated with the computer 902. Hard disk drives, removable media, computer-readable storage media, etc. can be communicatively coupled to the processing unit 904 by way of the system bus 908.

The system memory 906 can retain a number of program modules, such as an operating system, one or more application programs, other program modules, and program data. All or portions of an operating system, applications, modules, and/or data can be, for instance, cached in RAM, retained upon a hard disk drive, or any other suitable location. A user can enter commands and information into the computer 902 through one or more wired/wireless input devices, such as a keyboard, pointing and clicking mechanism, pressure sensitive screen, microphone, joystick, stylus pen, etc. A monitor or other type of interface can also be connected to the system bus 908.

The computer 902 can operate in a networked environment using logical connections via wired and/or wireless communications to one or more remote computers, phones, or other computing devices, such as workstations, server computers, routers, personal computers, portable computers, microprocessor-based entertainment appliances, peer devices or other common network nodes, etc. The computer 902 can connect to other devices/networks by way of antenna, port, network interface adaptor, wireless access point, modem, and/or the like.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out, anywhere within the range of a base station. WiFi networks use radio technologies called IEEE 802.11 (a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

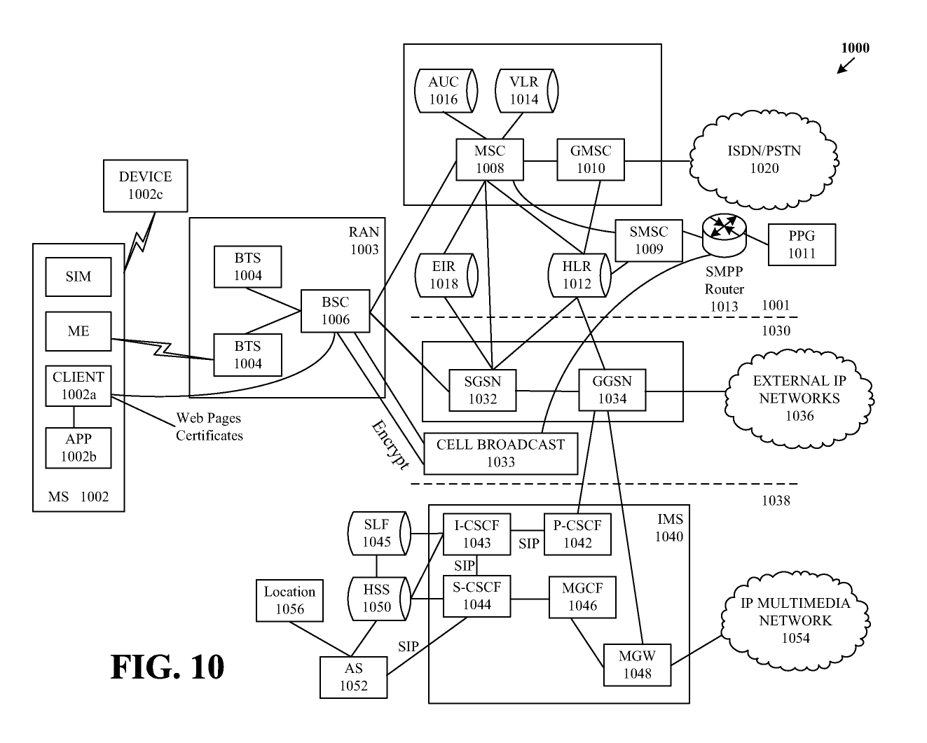

Now turning to FIG. 10, such figure depicts a GSM/GPRS/IP multimedia network architecture 1000 that includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM). The SIM includes an International Mobile Subscriber Identity (IMSI), which is a unique identifier of a subscriber. The MS 1002 includes an embedded client 1002a that receives and processes messages received by the MS 1002. The embedded client 1002a can be implemented in JAVA and is discuss more fully below.

The embedded client 1002a communicates with an application 1002b that provides services and/or information to an end user. One example of the application can be navigation software that provides near real-time traffic information that is received via the embedded client 1002a to the end user. The navigation software can provide road conditions, suggest alternate routes, etc. based on the location of the MS 1002. Those of ordinary skill in the art understand that there are many different methods and systems of locating an MS 1002.

Alternatively, the MS 1002 and a device 1002c can be enabled to communicate via a short-range wireless communication link, such as BLUETOOTH. For example, a BLUETOOTH SIM Access Profile can be provided in an automobile (e.g., device 1002c) that communicates with the SIM in the MS 1002 to enable the automobile's communications system to pull information from the MS 1002. The BLUETOOTH communication system in the vehicle becomes an “embedded phone” that employs an antenna associated with the automobile. The result is improved reception of calls made in the vehicle. As one of ordinary skill in the art would recognize, an automobile is one example of the device 1002c. There can be an endless number of devices 1002c that use the SIM within the MS 1002 to provide services, information, data, audio, video, etc. to end users.

The BTS 1004 is physical equipment, such as a radio tower, that enables a radio interface to communicate with the MS. Each BTS can serve more than one MS. The BSC 1006 manages radio resources, including the BTS. The BSC can be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. In other words, the GMSC 1010 provides interworking functionality with external networks.

The HLR 1012 is a database or component(s) that comprises administrative information regarding each subscriber registered in a corresponding GSM network. The HLR 1012 also includes the current location of each MS. The VLR 1014 is a database or component(s) that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (e.g., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. It is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location-updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 1033 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time. A class B MS can attach to the network for both GPRS services and GSM services simultaneously. However, a class B MS does not support simultaneous operation of the GPRS services and GSM services. That is, a class B MS can only use one of the two services at a given time. A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS cannot receive pages from a circuit switched domain when engaged in a data call, since the MS is receiving data and is not listening to a paging channel. In a NOM3 network, a MS can monitor pages for a circuit switched network while received data and vise versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 can be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 can also modify an outgoing request according to a set of rules defined by the network operator (for example, address analysis and potential modification).

The I-CSCF 1043 forms an entrance to a home network and hides the inner topology of the home network from other networks and provides flexibility for selecting an S-CSCF. The I-CSCF 1043 can contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that presents visual cues to a user in a threaded messaging environment to facilitate correlating messages to particular conversants, comprising:
a message source designation component that provides access to information relating to the source of a message;
a communication bubble rendering component, that can at least in part facilitate rendering a communication bubble, further comprising at least one of:
a conversation bubble tail component facilitating adaptation of one or more conversation bubble tails based at least in part on the source of the message;
a conversation bubble drop-shadow component facilitating adaptation of one or more conversation bubble drop-shadows; and
a conversation bubble footprint component facilitating adaptation of one or more conversation bubble footprints; and
wherein at least one of a conversation bubble tail, a conversation bubble drop-shadow, an adapted conversation bubble footprint, or combination thereof is included in a rendered conversation bubble made accessible to at least one conversant by presentation on a display device.

2. The system of claim 1, further comprising a message content component that facilities access to information relating to message content, message content objects, or combinations thereof, such that said information can be accessed by the conversation bubble footprint component to at least in part facilitate adaptation of one or more conversation bubble footprint renderings to encompass the message content, content object, or combination thereof.

3. The system of claim 2, wherein adaptation of the one or more conversation bubble footprint renderings to encompass the message content, content object, or combination thereof is performed dynamically in response to fluctuations in the state of a related message content, content object, or combination thereof.

4. The system of claim 3, wherein the fluctuations in the state of the related message content, content object, or combination thereof is based at least in part on a change in the focus state of the user in the threaded messaging environment, a change in the content or content object related to the execution of computer based instructions related to the content or content object, or combinations thereof.

5. The system of claim 1, wherein the rendered conversation bubble includes an indexed conversation bubble tail, said index being related to a particular conversant of the threaded messaging environment, and wherein other messages in the threaded message environment having conversation bubbles with similar indexing are more likely to be attributable to the same conversant.

6. The system of claim 5, wherein the index is related to a horizontal indentation of the conversation bubble tail from at least one predetermined horizontal reference point of the display.

7. The system of claim 1, wherein the rendered conversation bubble includes a conversation bubble drop-shadow having at least one visually identifiable characteristic, said drop-shadow being related to a particular conversant of the threaded messaging environment, and wherein other messages in the threaded message environment having conversation bubbles with drop-shadows with similar identifiable characteristics are more likely to be attributable to the same conversant.

8. The system of claim 7, wherein the at least one visually identifiable characteristic includes at least one of drop-shadow size, drop-shadow perceived depth, drop-shadow opacity, drop-shadow color, or some combination thereof.

9. The system of claim 1, wherein:
the rendered conversation bubble includes at least a conversation bubble tail and a conversation bubble drop-shadow in a rendered conversation bubble;
the conversation bubble tail being indexed, said index being related to a particular conversant of the threaded messaging environment;
the conversation bubble drop-shadow includes at least one visually identifiable characteristic, and
the combination of drop-shadow characteristics and tail indexing is related to a particular conversant of the threaded messaging environment such that other messages in the threaded message environment having conversation bubbles with similar drop-shadowing characteristics and indexing are more likely to be attributable to the same conversant.

10. The system of claim 1, wherein the conversation bubble tail component further comprises at least one of:
a time component to facilitate inclusion of a time indicator in a rendered conversation bubble; and
a name component to facilitate inclusion of a name indicator in a rendered conversation bubble.

11. The system of claim 10, wherein a rendered time indicator, if any, indicates time received, time sent, date, day, time since last message from the same conversant, or some combination thereof, and wherein a rendered name indicator, if any, indicates the relevant conversant's first name, last name, nickname, phone number, identification number, symbol, image, caricature, or some combination thereof.

12. A method for presenting visual cues to a user in a threaded messaging environment to facilitate correlating messages to particular conversants, comprising:
determining a message source designation to facilitate accessing information related at least in part to a particular conversant;
applying a conversation bubble tail based at least in part on information relating to the source designation of the message;
applying a conversation bubble drop-shadow based at least in part on information relating to the source designation of the message;
rendering a conversation bubble including the applied conversation bubble tail and conversation bubble drop-shadow; and
making the rendered conversation bubble accessible to at least one conversant by presentation on a display device.

13. The method of claim 12, wherein the conversation bubble tail is indexed, said index being related to a particular conversant of the threaded messaging environment, and wherein other messages in the threaded message environment having conversation bubbles with similar indexing are more likely to be attributable to the same conversant.

14. The method of claim 13, wherein the conversation bubble tail index is based on a percentage of the width of a display area of the display device in the normal reading direction of the displayed message.

15. The method of claim 12, wherein the conversation bubble drop-shadow has at least one visually identifiable characteristic, said drop-shadow being related to a particular conversant of the threaded messaging environment, and wherein other messages in the threaded message environment having conversation bubbles with drop-shadows with similar identifiable characteristics are more likely to be attributable to the same conversant.

16. The method of claim 15, wherein the at least one visually identifiable characteristic includes at least one of drop-shadow size, drop-shadow perceived depth, drop-shadow opacity, drop-shadow color, or some combination thereof.

17. The method of claim 12 further comprising:
determining the content of a message;
determining if the content will be resized to accommodate available display area of the display device;
adapting the conversation bubble footprint to encompass the message content to facilitate visual distinction of the contents of the message from other messages in the threaded messaging environment and thereby better relating the content of the message to a particular conversant.

18. The method of claim 17, wherein adapting of the conversation bubble footprint is dynamic with regard to fluctuations in the state of message content.

19. The method of claim 18, wherein the fluctuations in the state of the message content is based at least in part on a change in the focus state of the user in the threaded messaging environment, a change in the content related to the execution of computer based instructions related to the content, or combinations thereof.

20. A computer based system embodied in a mobile device, that presents visual cues to a user participating in a group threaded messaging conversation, to facilitate the user in attributing messages with similar visual cues to particular conversants of the group threaded messaging conversation, comprising:
a conversant identification component that associates a particular conversant with a message received for the group threaded messaging conversation;
a communication bubble rendering component, that can at least in part facilitate rendering a communication bubble, further comprising:
a conversation bubble indexed tail component facilitating adaptation of one or more conversation bubble tails based to include indexing related at least in part to the identification of the conversant associated with the message;
a conversation bubble color drop-shadow component facilitating adaptation of one or more conversation bubble drop-shadows to include color related at least in part to the identification of the conversant associated with the message; and
a dynamic conversation bubble footprint component facilitating dynamic adaptation of one or more conversation bubble footprints of the group threaded messaging conversation to encompass the contents of the message as the state of the contents of a message fluctuate, wherein the fluctuations in the state of the message content is based at least in part on a change in the determined focus state of the user in the threaded messaging conversation, a change in the content related to the execution of computer based instructions related to the content, or combinations thereof, and
wherein an adapted conversation bubble is rendered and made accessible to at least one conversant by presentation on a display device.
